(19) United States
(12) Patent Application Publication
(10) Pub. No.: US 2008/0147687 A1
(43) Pub. Date: Jun. 19, 2008

(54) Information Management System and Document Information Management Method

(76) Inventors: Naohiro Furukawa, Tachikawa (JP); Hisashi Ikeda, Kunitachi (JP); Makoto Iwayama, Tokorozawa (JP); Osamu Imaichi, Wako (JP); Yusuke Sato, Kokubunji (JP)

Correspondence Address: REED SMITH LLP, 3110 FAIRVIEW PARK DRIVE, SUITE 1400, FALLS CHURCH, VA, 22042, US

(21) Appl. No.: 11/793,544

(22) PCT Filed: Feb. 17, 2005
(86) PCT No.: PCT/JP2005/002954

§ 371 Date: Jun. 21, 2007

(51) Int. Cl. G06F 17/30

(52) U.S. Cl. 707/100; 707/E17.044

(57) ABSTRACT

Provided in this invention is an information management system including a coordinate acquisition device for identifying a position on paper and a contents server for storing document data, characterized in that: the document data includes original document data and summary document data including the original document data; the original document data includes a first coordinate system and contents; the summary document data includes a second coordinate system, information about link to the original document data and coordinate information about areas assigned to the original document data; and in a case where the coordinate acquisition device identifies a position on the summary document, the contents server converts the coordinates of the identified position in the second coordinate system to coordinates in the first coordinate system.

### TECHNICAL FIELD

This invention relates to an information management system for managing documents and the like, in particular, to a technique for retrieval, selection and correction of a managed document.

### BACKGROUND ART

In recent years, with the development of electronics technology, it becomes possible to easily electronize information handwritten on paper.

At present, only electronic documents obtained by electronizing paper documents are managed on computers. Under such management, information handwritten on paper documents is not electronically managed, and the handwritten information cannot be effectively utilized.

As a technique for solving this problem, there is proposed a hybrid document management system capable of managing handwritten information. This hybrid document management system manages documents which include handwritten information, without distinguishing paper documents and electronic documents from each other. However, in the hybrid document management system, it is difficult to effectively retrieve a target document if a large number of documents are accumulated.

As a technique for solving this problem, an information retrieval system described in Japanese Patent Laid-open No. 06-44320 is known. This information retrieval system reduces the page size of documents and prints the multiple reduced-size documents and the identification codes corresponding to the respective documents on paper. A target document is retrieved by reading the printed identification code with a code reader.

With increase in the capacity of storage media, it has become possible to record a long video easily and inexpensively. Accordingly, various videos related to our life are stored. It is expected that, in the future, various videos such as business meeting videos and university lecture videos are also stored in addition to TV program videos and family videos that have been stored conventionally.

Accordingly, a technique is conceivable in which the hybrid document management system manages documents as well as videos related thereto. However, in the current hybrid management system, it is difficult to retrieve a desired video from among the managed videos. Therefore, how effectively a desired video is retrieved and utilized is a serious problem for the hybrid document management system.

A pen-type input device (digital pen) for electronically acquiring the trace of a pen point has been practically used. The digital pen inputs the acquired trace of the pen point to a computer. For example, “Anoto Pen” developed by Anoto Group AB in Sweden is an example of the digital pen. The details of this digital pen are described in International Patent Laid-open No. 01/71473. The digital pen is advantageous in that even a user who is unfamiliar with the use of a keyboard and a mouse can easily use it, and it is expected that the digital pen is applied to application works in an electronic government and other fields.

### DISCLOSURE OF THE INVENTION

According to conventional information retrieval systems, it is possible to retrieve a target document by referring to paper on which documents with a reduced page size are printed. However, even if information is handwritten on the paper on which the documents with a reduced page size are printed, the handwritten information is not reflected on the original document. Further, it is impossible to retrieve information such as a video, related to the retrieved document.

In order to solve the above-mentioned problems, an object of this invention is to provide a document management system which, when information is handwritten on a summary document including original documents with a reduced page size, reflects the handwritten information on the original document.

This invention provides an information management system including a coordinate acquisition device for identifying a position on paper and a contents server for storing document data, characterized in that: the document data includes original document data and summary document data including the original document data; the original document data includes a first coordinate system and contents; the summary document data includes a second coordinate system, information about link to the original document data and coordinate information about areas assigned to the original document data; and in a case where the coordinate acquisition device identifies a position on the summary document, the contents server converts the coordinates of the identified position in the second coordinate system to coordinates in the first coordinate system.

According to this invention, it is possible to, when information is handwritten on a summary document including original documents with a reduced page size, reflect the handwritten information on the original document.

### BRIEF DESCRIPTION OF THE DRAWINGS

FIG. 1 is a block diagram of a document management system of an embodiment of this invention.

FIG. 2 is an explanatory diagram illustrating the outline of the processing by the document management system of the embodiment of this invention.

FIG. 3 is a block diagram of a contents server of the embodiment of this invention.

FIG. 4 is a block diagram of an information terminal of the embodiment of this invention.

FIG. 5 is an explanatory diagram illustrating a digital pen of the embodiment of this invention.

FIG. 6 is a structure diagram of event information managed by an event management section of the contents server of the embodiment of this invention.

FIG. 7A is a structure diagram of document information about a document with no link which is managed by a document management section of the contents server of the embodiment of this invention.

FIG. 7B is a structure diagram of document information about a document with link which is managed by the document management section of the contents server of the embodiment of this invention.

FIG. 8A shows an example of a stroke set of the embodiment of this invention.

FIG. 8B is a structure diagram of stroke set information managed by a stroke set management section of the contents server of the embodiment of this invention.

FIG. 8C is a structure diagram of stroke coordinate information managed by the stroke set management section of the contents server of the embodiment of this invention.

FIG. 9 is a structure diagram of user information managed by a user management section of the contents server of the embodiment of this invention.

FIG. 10 is an explanatory diagram illustrating an event registration form of the embodiment of this invention.

FIG. 11 is a sequence diagram of the event registration processing by the document management system of the embodiment of this invention.

FIG. 12 is an explanatory diagram illustrating a document to be registered with the contents server of the embodiment of this invention.

FIG. 13 is an explanatory diagram illustrating the document in which information has been handwritten with a digital pen of the embodiment of this invention.

FIG. 14 is an explanatory diagram illustrating a search form of the embodiment of this invention.

FIG. 15 is a sequence diagram of the event search processing by the document management system of the embodiment of this invention.

FIG. 16 is an explanatory diagram illustrating a summary document of the embodiment of this invention.

FIG. 17 is an explanatory diagram illustrating the summary document for which video search processing of the embodiment of this invention is specified.

FIG. 18 is an explanatory diagram illustrating the summary document for which document addition processing of the embodiment of this invention is specified.

FIG. 19 is an explanatory diagram illustrating the document for which the document addition processing of the embodiment of this invention has been performed.

FIG. 20 is a sequence diagram of the summary document operation processing by the document management system of the embodiment of this invention.

FIG. 21 is a structure diagram of document information about the document for which the document addition processing of the embodiment of this invention has been performed.

### BEST MODE FOR CARRYING OUT THE INVENTION

An embodiment of this invention will be described below with reference to drawings.

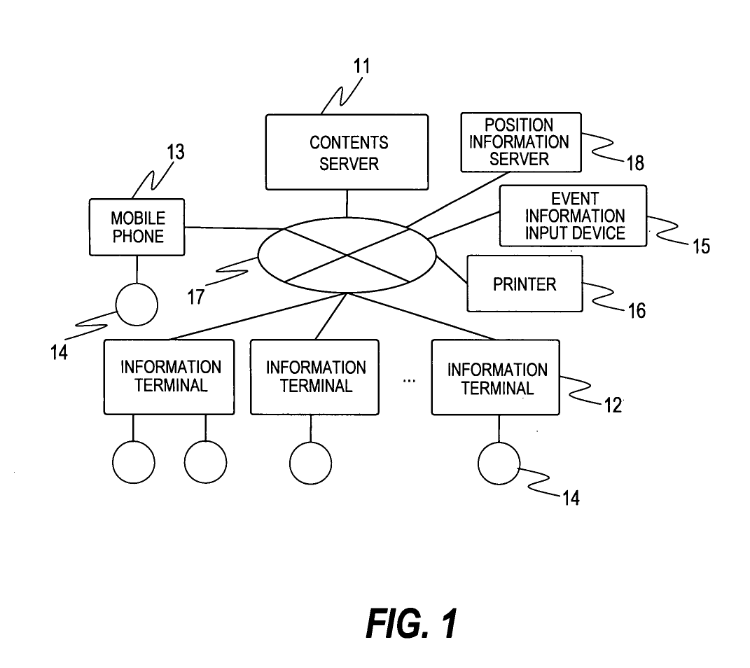

FIG. 1 is a block diagram of a document management system of an embodiment of this invention.

The document management system is provided with a contents server 11, an information terminal 12, a digital pen 14, an event information input device 15, a printer 16, a network 17, and a position information server 18.

The contents server 11, the information terminal 12, the event information input device 15, the printer 16, and the position information server 18 are connected to one another via the network 17. The information terminal 12 is connected to one or more digital pens 14. The information terminal 12 and the digital pen 14 may be connected by wire to each other with the use of a protocol such as USB (Universal Serial Bus), or they may be wirelessly connected through Bluetooth, WirelessLAN, infrared, or the like. The printer 16 may be directly connected to the information terminal 12.

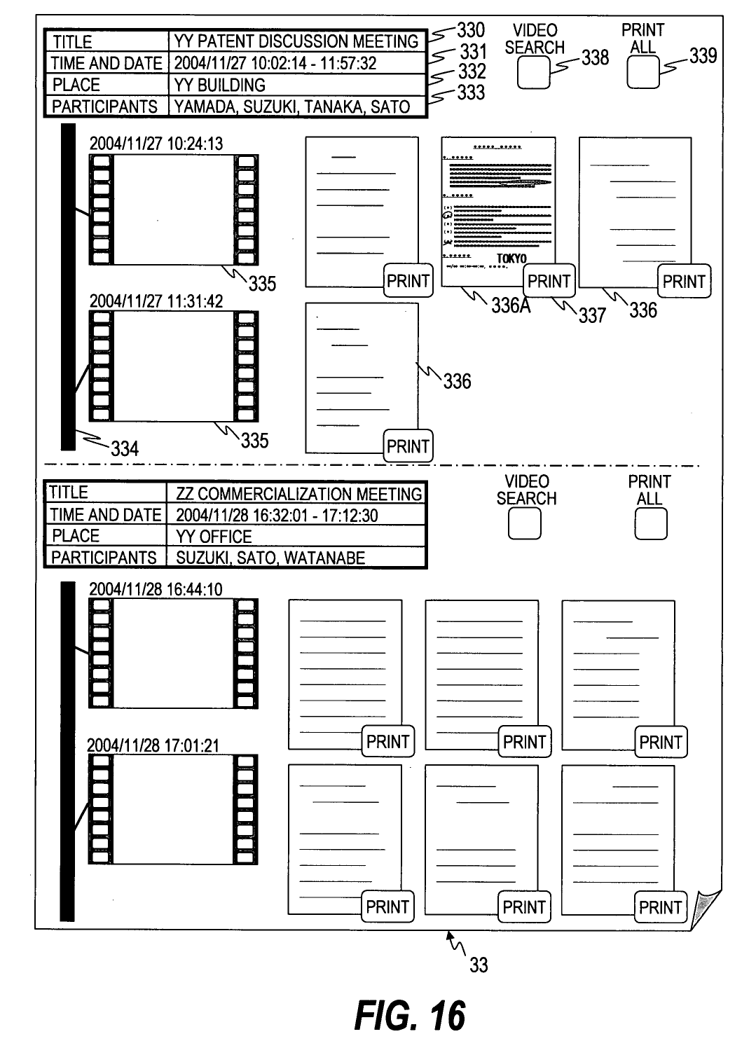

The contents server 11 manages contents for each event and sends requested contents to the information terminal 12. The contents include documents, videos, voices, images, slides, and the like related to the event. The documents includes all information that can be printed on paper, and also includes a summary document to be described later with reference to FIG. 16.

The information terminal 12 transfers information received from the digital pen 14 to the contents server 11. The information terminal 12 also displays contents received from the contents server 11.

The digital pen 14 allows a user to handwrite a character or hand-draw a figure on a paper similarly to an ordinary pen. The digital pen 14 is provided with a small-sized camera at the tip to acquire a dot pattern at the position on the paper which the digital pen 14 is touching. The digital pen 14 also holds the user ID of the user who owns the digital pen. The digital pen 14 is provided with an interface for connecting to the information terminal 12 by wire or wireless.

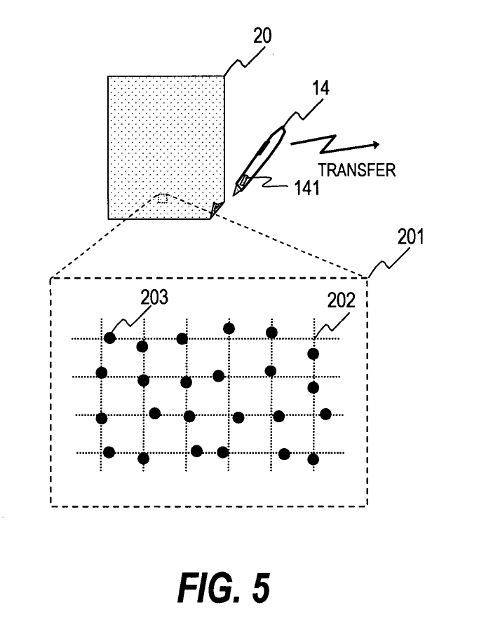

For example, as shown in FIG. 5, the digital pen 14 acquires a dot pattern printed on a document. Then, from the dot pattern acquired by the digital pen 14, the coordinates on the paper can be identified.

The digital pen 14 may send the identified absolute coordinates, the time when the dot pattern was acquired, and the user ID, to the contents server 11 not via the information terminal 12 but via a mobile phone 13 or a wireless LAN.

The event information input device 15 is a computer device installed in a meeting room, which creates information related to an event (for example, video, images, voices, and/or slides). The event information input device 15 also registers documents and created contents such as video with the contents server 11 in association with the event.

The position information server 18 is a computer device provided with a CPU, a memory, a storage device, and the like and holds a database for calculating a document ID and relative coordinates from absolute coordinates. The position information server 18 may be included in the contents server 11, rather than being separately provided.

The printer 16 prints contents such as a document in response to an instruction from the information terminal 12.

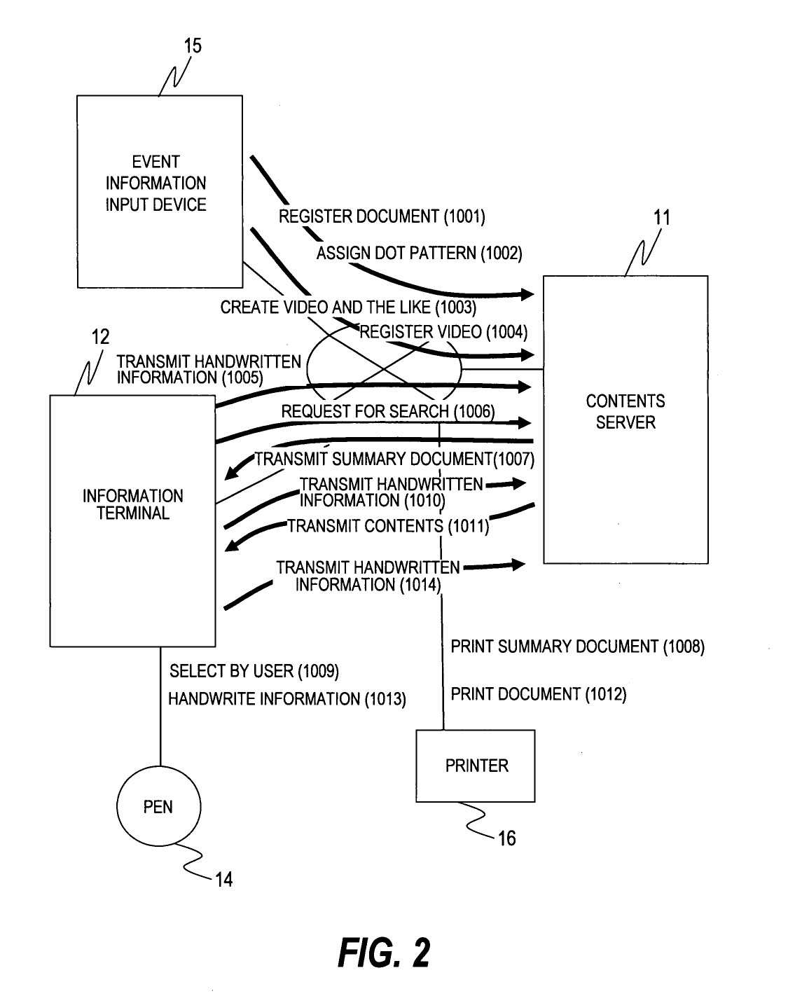

FIG. 2 is a diagram illustrating an outline of the processing performed by the document management system of the embodiment of this invention.

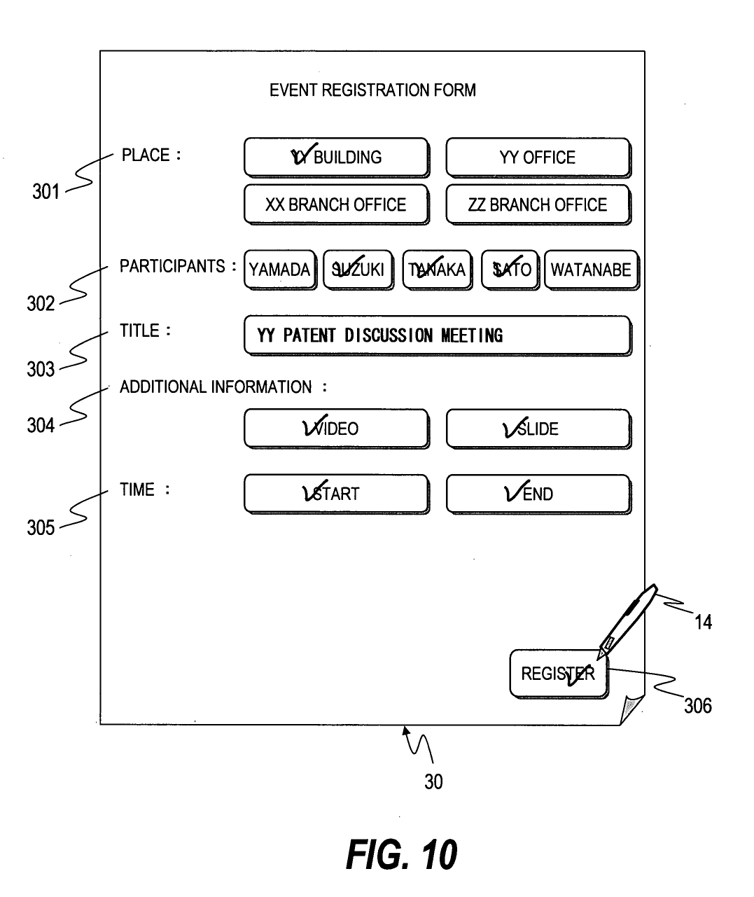

First, a user inputs information related to an event to an event registration form to be described later with reference to FIG. 10, with the use of the digital pen 14. Then, the information terminal 12 registers the inputted information with the contents server 11 as event information.

Next, the user inputs documents related to the registered event to the event information input device 15. Then, the event information input device 15 registers the inputted documents with the contents server 11 in association with the event (1001). The event information input device 15 may register each document with the contents server 11 each time the document is inputted or may collectively register multiple inputted documents at a predetermined timing.

Next, the contents server 11 assigns arbitrary dot patterns which do not overlap with one another to the registered documents (1002). In the case where there are multiple participants of the event, arbitrary dot patterns which do not overlap with one another are assigned to the documents for the respective participants.

Next, the event information input device 15 creates a video related to the registered event (1003). The event information input device 15 may create images, voices, or slides related to the event together with the video.

Next, the event information input device 15 registers the created video and the like with the contents server 11 in association with the event (1004). The event information input device 15 may register the video in real time.

Next, the user handwrites a character or hand-draws a figure on the document with the use of the digital pen 14. Then, the digital pen 14 acquires stroke information corresponding to the information handwritten or drawn by the user. The stroke information includes the absolute coordinates of the position on the document which the digital pen 14 is touching, the time when the absolute coordinates are acquired and the like.

Then, the digital pen 14 sends handwritten information including the acquired stroke information, the ID of the user who handwrote the character corresponding to the stroke information, and the like to the contents server 11 via the information terminal 12 (1005). The digital pen 14 may send the handwritten information in real time or may send the information collectively after the user has completed the handwriting.

Based on the stroke information and the user ID included in the received handwritten information, the contents server 11 reflects the stroke information on the document registered in step 1001. In other words, the contents server 11 stores the document which is in the condition when the information has been handwritten by the user.

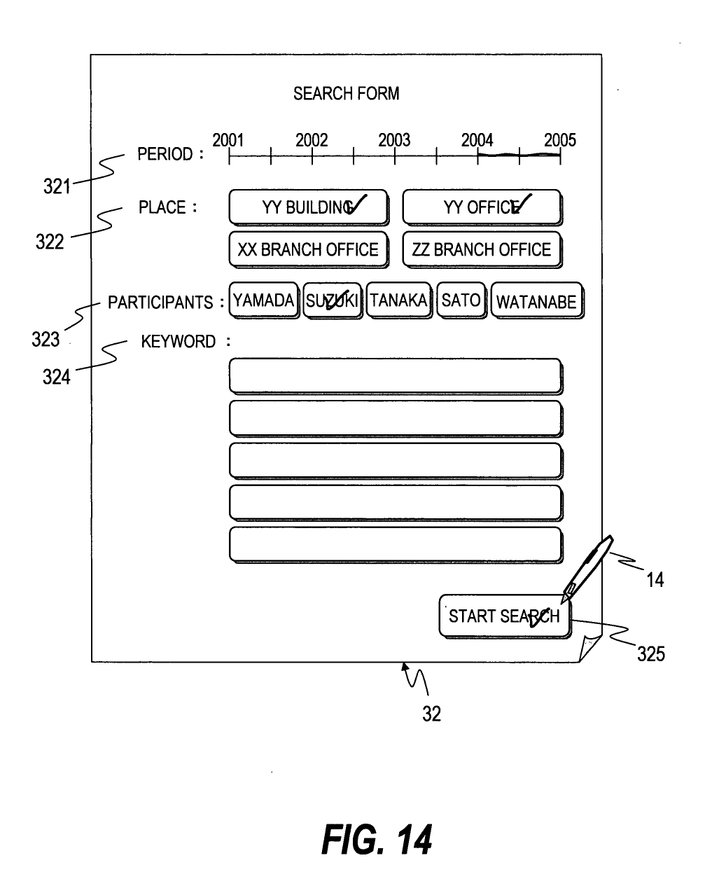

Next, by operating the information terminal 12 or the digital pen 14, the user specifies event search conditions. For example, the user handwrites the search conditions on a search form 32 to be described later with reference to FIG. 14, with the use of the digital pen 14. The search conditions include, for example, an event name, a place where the event is held, participants, keywords, and the like. The operated information terminal 12 or the digital pen 14 sends a search request including the specified search conditions to the contents server 11 (1006).

When receiving the search request, the contents server 11 searches for an event which satisfies the search conditions included in the search request. Then, the contents server 11 creates a summary document about the searched event. Specifically, the contents server 11 creates the summary document by reducing the page size of the documents related to the event and attaching the reduced documents to a template. The contents server 11 may extract images corresponding to several frames of images from the video related to the event and attach the extracted images to the template. The template may be set in advance, or the user may select one from among multiple templates prepared in advance.

Then, the contents server 11 assigns an arbitrary dot pattern that does not overlap with another dot patterns for another document to the created summary document. Next, the contents server 11 sends the summary document to which the dot pattern has been assigned, to the information terminal 12 (1007).

The information terminal 12 receives the summary document from the contents server 11. Next, the information terminal 12 displays the received summary document. Further, the information terminal 12 instructs the printer 16 to print the received summary document. Then, the printer 16 prints the specified summary document (1008).

Next, by operating the digital pen 14 on the printed summary document, the user selects contents which the user requests to acquire (1009). Then, the digital pen 14 acquires stroke information corresponding to the user's operation. After that, the digital pen 14 sends handwritten information including the acquired stroke information and a preset user ID to the contents server 11 via the information terminal 12 (1010). The user may select the contents which the user requests to acquire, by operating the data input section of the information terminal 12. In this case, the information terminal 12 sends a request for the selected contents to the contents server 11.

The contents server 11 extracts the stroke information from the received handwritten information. Then, the contents server 11 determines the contents requested by the user on the basis of the extracted stroke information. Next, the contents server 11 sends the determined contents to the information terminal 12 (1011).

Receiving the contents, the information terminal 12 displays the contents. If the received contents include a document, the information terminal 12 instructs the printer 16 to print the document. The printer 16 prints the specified document (1012).

Next, the user handwrites information on the printed document with the use of the digital pen 14 (1013). Then, the digital pen 14 acquires stroke information corresponding to the information handwritten by the user. After that, the digital pen 14 sends handwritten information including the acquired stroke information, the user ID, and the like to the contents server 11 via the information terminal 12 (1014).

Then, the contents server 11 reflects the stroke information included in the received handwritten information, on the document. If the user handwrites information on the summary document, the contents server 11 reflects the handwritten information not only on the summary document but also on the document attached into the area on the summary document where the user wrote the information.

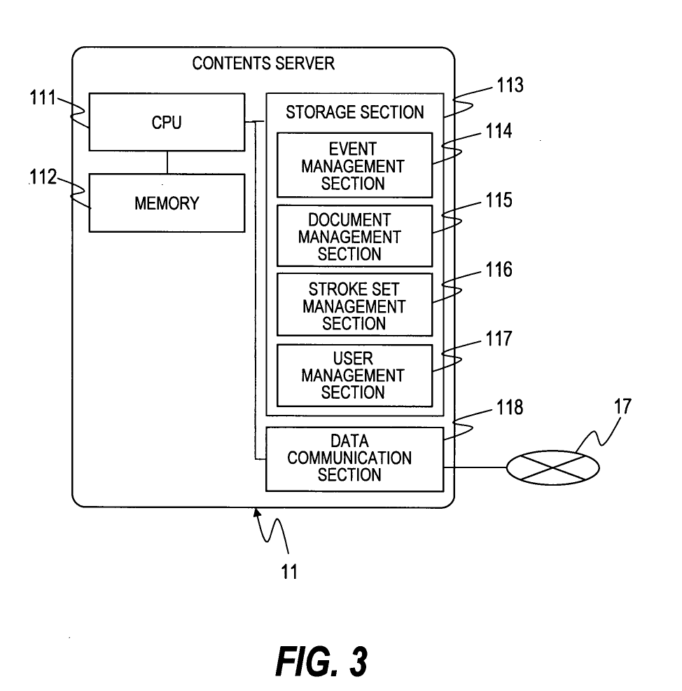

FIG. 3 is a block diagram of the contents server 11 of the embodiment of this invention.

The contents server 11 is provided with a CPU 111, a memory 112, a storage section 113, and a data communication section 118.

The CPU 111 performs various processings by calling up and executing various programs stored in the storage section 113. The memory 112 has a work area for temporarily storing data to be used by the CPU 111 for the various processings. The memory 112 also temporarily stores various information sent from the information terminal 12 and the like.

The storage section 113 includes a non-volatile storage medium (for example, a magnetic disk drive). The storage section 113 stores programs for realizing the respective sections provided for the contents server 11 and information managed by the programs.

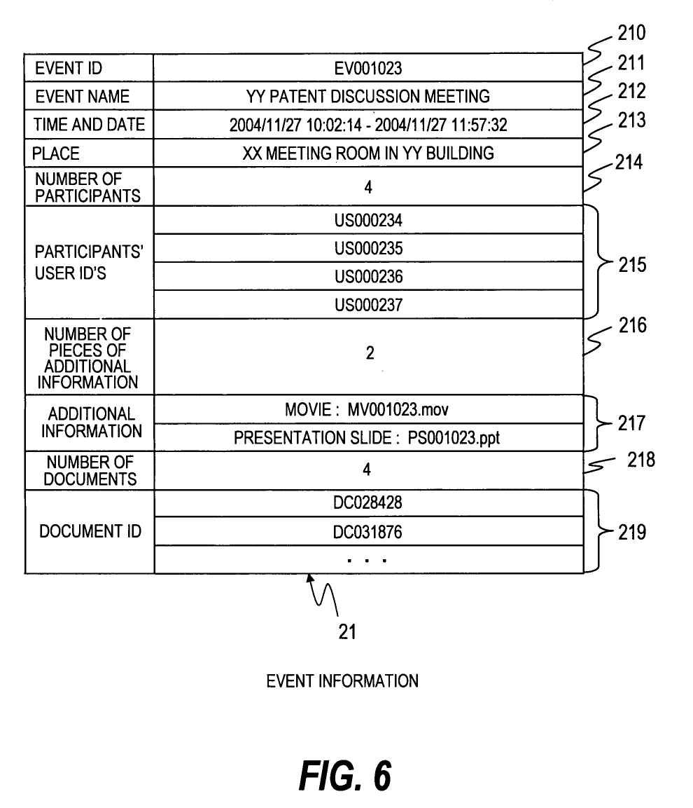

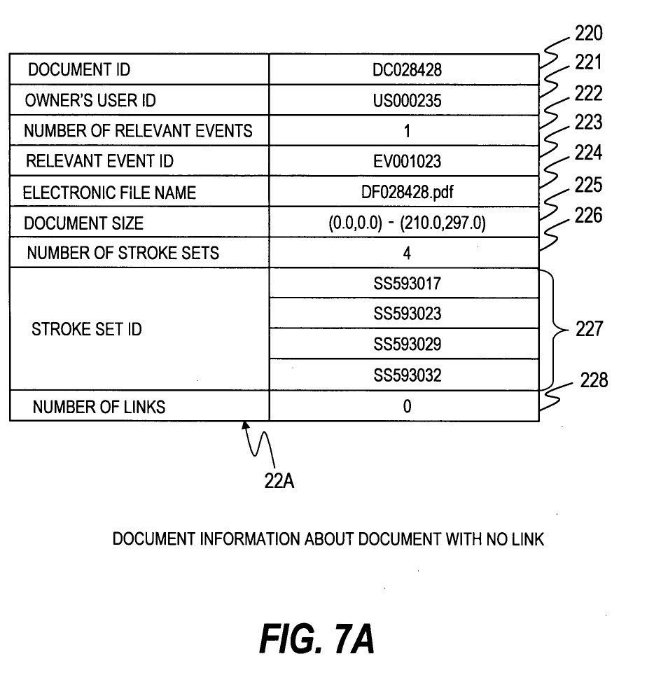

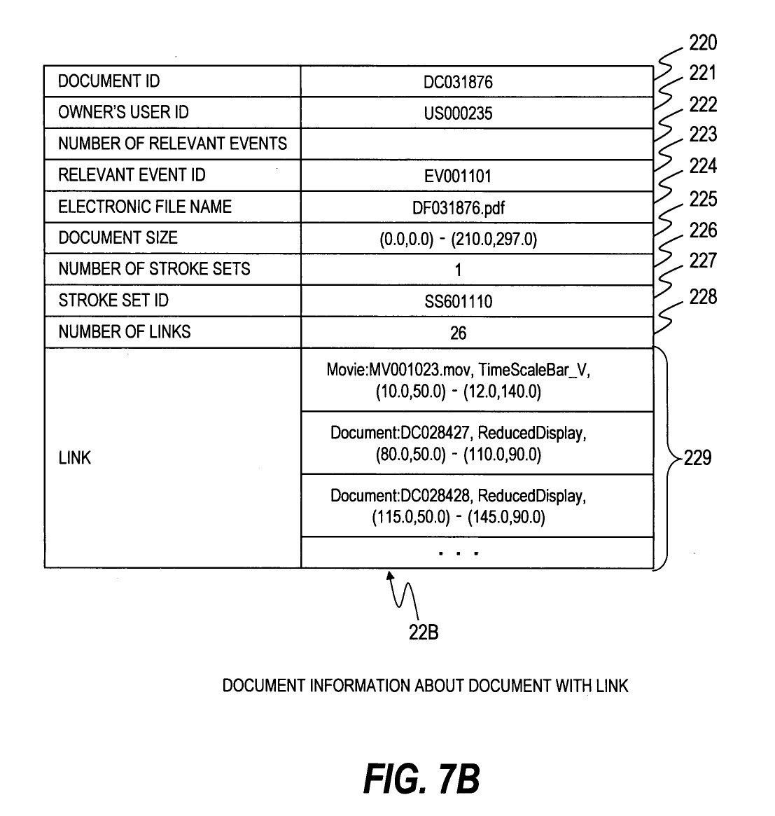

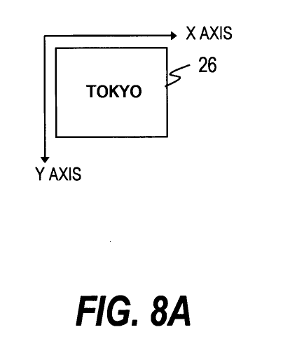

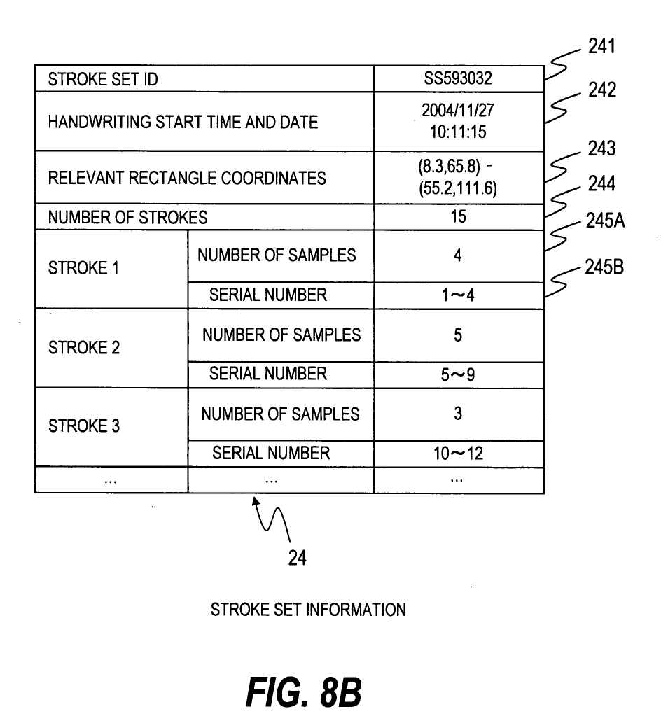

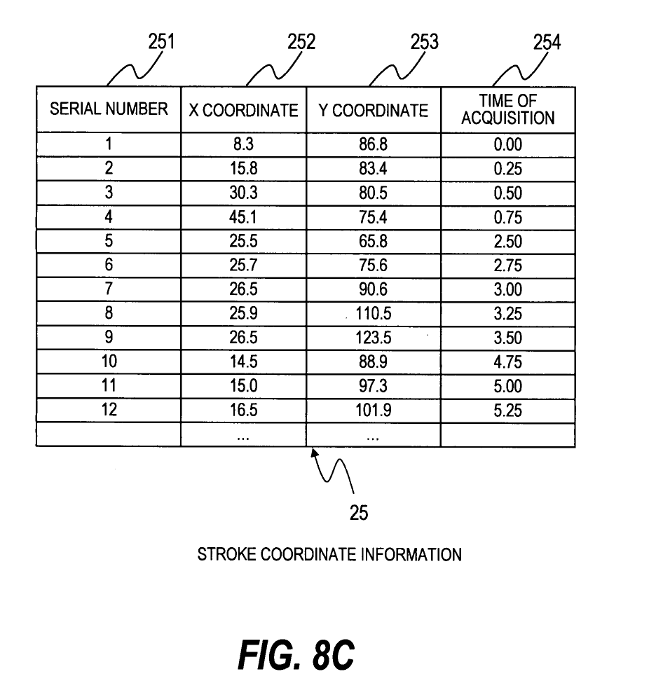

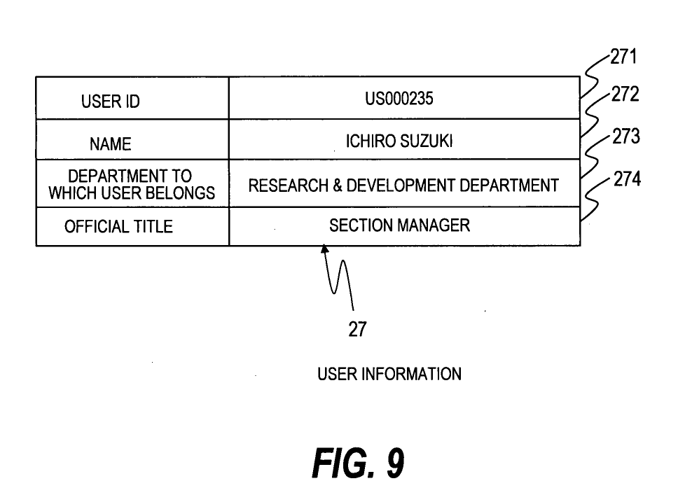

Specifically, an event management section 114, a document management section 115, a stroke set management section 116, and a user management section 117 are realized by those programs and data. The event management section 114 manages event information (FIG. 6). The document management section 115 manages document information (FIGS. 7A and 7B). The stroke set management section 116 manages stroke set information (FIG. 8B) and stroke coordinate information (FIG. 8C). The user management section 117 manages user information (FIG. 9).

The data communication section 118 is a network interface, and includes, for example, a LAN card capable of performing communication with the use of the TCP/IP protocol.

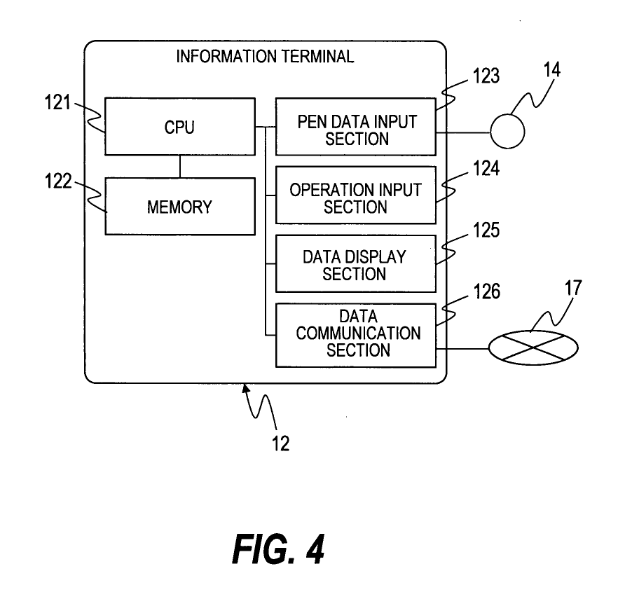

FIG. 4 is a block diagram of the information terminal 12 of the embodiment of this invention.

The information terminal 12 is provided with a CPU 121, a memory 122, a pen data input section 123, an operation input section 124, a data display section 125, and a data communication section 126.

The CPU 121 performs various processings by calling up and executing various programs stored in a storage section (not shown).

The memory 122 has a work area for temporarily storing data to be used by the CPU 121 for the various processings. The memory 122 also temporarily stores various information sent from the contents server 11, the digital pen 14, and the like.

The pen data input section 123 communicates with the digital pen 14 by wire or wireless to collect information such as absolute coordinates identified by the digital pen 14.

The operation input section 124 includes, for example, a keyboard, through which information is inputted by the user.

The data display section 125 includes, for example, a liquid crystal display, which displays contents, such as a document, acquired from the contents server 11. The data communication section 126 is a network interface, which includes, for example, a LAN card capable of performing communication with the use of the TCP/IP protocol. Through the data communication section 126, the information terminal 12 can communicate with the contents server 11 via a network.

The pen data input section 123 and the data communication section 126 may constitute a single interface.

FIG. 5 is a diagram illustrating acquisition of coordinates on paper by the digital pen 14 of the embodiment of this invention.

The digital pen 14 is provided with a CPU, a memory, a processor, a communication interface, a camera 141, a battery, and a writing pressure sensor. The digital pen 14 is also provided with a pen point which can be used for writing in ink or graphite.

The digital pen 14 is used together with paper 20 on which dots 203 used for position detection are printed. Here, the dots 203 will be described with the use of an enlarged part 201 of the paper 20. The multiple small dots 203 are printed on the paper 20. The dots 203 are printed at positions horizontally or vertically displaced from the intersection points 202 of a virtual grid (reference point).

When a character or a figure is handwritten or drawn with the digital pen 14 on the paper, the information visibly remains on the paper. When the writing pressure sensor senses the pen point touching the paper, the digital pen 14 photographs the dots 203 printed on the paper, with the camera 141. The digital pen 14 takes an image of an area including, for example, 6×6 dots 203.

The digital pen 14 determines, based on the photographed dot pattern, the absolute coordinates on which the dot pattern exists. The absolute coordinates represent the coordinates on which the dot pattern exists, in a vast plane area. The vast plane area includes all the area in which the dot patterns can be arranged without being overlapped with one another.

The digital pen 14 sends the determined absolute coordinates to the information terminal 12. The information terminal 12 sends the absolute coordinates sent from the digital pen 14, to the contents server 11.

The contents server 11 sends the absolute coordinates determined by the digital pen 14 to the position information server 18. The position information server 18 identifies the position of the page in the vast plane area (document ID) and the coordinates on one certain page (relative coordinates) on the basis of the absolute coordinates sent from the contents server 11, and sends the identified document ID and the relative coordinates to the contents server 11.

In this way, the contents server 11 acquires the document ID and the relative coordinates from the dot pattern photographed by the digital pen 14.

By acquiring information about the position in which the pen point is touching, at a predetermined timing (for example, periodically), the movement of the pen point is recognized.

In other words, the digital pen 14 sends the absolute coordinates corresponding to the photographed dot pattern, the time when the dot pattern was photographed, and the user ID to the information terminal 12.

The contents server 11 acquires relative coordinates from the position information server 18 on the basis of the absolute coordinates determined by the digital pen 14. The contents server 11 determines the trace of the pen point (stroke set information) from the acquired relative coordinates and the time when the dot pattern was photographed.

The digital pen 14 may send the document ID and the relative coordinates to the contents server 11 instead of the absolute coordinates. In this case, by sending the acquired absolute coordinates to the position information server 18, the digital pen 14 identifies the document ID and the relative coordinates corresponding to the absolute coordinates.

However, the digital pen 14 does not have to use the position information server 18 to identify the document ID and the relative coordinates. For example, the digital pen 14 identifies the document ID from an IC tag or a two-dimensional bar code embedded in the paper 20. Further, the position on the paper (the relative coordinates) can be identified with the use of a tablet. Any of the identification of the document ID with the use of a μ chip or the like and the identification of the relative coordinates with the use of a tablet may be combined with the identification of the absolute coordinates by the position information server 18. This enables the document management system to reduce the processing for identifying the document ID and the relative coordinates.

FIG. 6 is a structure diagram of event information 21 managed by the event management section 114 of the contents server 11 of the embodiment of this invention.

The event information 21 includes event ID 210, event name 211, time and date 212, place 213, the number of participants 214, participants' user IDs 215, the number of pieces of additional information 216, additional information 217, the number of documents 218, and document ID 219. The event information 21 is generated each time an event such as a meeting is held.

The event ID 210 is an identifier which uniquely identifies the event. For example, the event management section 114 automatically determines the event ID 210 in accordance with an arbitrary rule and records the event ID 210 in the event information 21.

The event name 211 is the name of the event.

As the time and date 212, the start time and end time of the event are recorded.

The place 213 indicates the name of the place where the event was held.

The number of participants 214 indicates the number of persons who participated in the event. The number of participants' user IDs 215 to be recorded is equal to the number of participants 214.

The participants' user IDs 215 are IDs each for uniquely identifying each participant of the event.

The number of pieces of additional information 216 is the number of pieces of information related to the event. The number of pieces of additional information 217 to be recorded is equal to the number of pieces of additional information 216.

As the additional information 217, the file names of video, images, voices, slides, and the like related to the event are recorded. For example, information such as video obtained by image-shooting the event, voices obtained by recording the event, and slides used in the event is recorded.

The number of documents 218 is the number of documents related to the event. The number of document IDs 219 to be recorded is equal to the number of documents 218.

The document ID 219 is an identifier which uniquely identifies a document related to the event.

FIG. 7A is a structure diagram of document information 22A related to a document with no link which is managed by the document management section 115 of the contents server 11 of the embodiment of this invention.

The document information 22A related to a document with no link includes document ID 220, owner's user ID 221, the number of relevant events 222, relevant event ID 223, electronic file name 224, document size 225, the number of stroke sets 226, stroke set ID 227 and the number of links 228.

The document ID 220 is an identifier which uniquely identifies the document. Even a document having the same information is considered to be a different document if it is owned by a different owner. The document is given a different document ID 220, and different document information 22 is created. In general, documents distributed to different users are printed together with different dot patterns for the respective users.

The owner's user ID 221 is an identifier which uniquely identifies the user who owns the document.

The number of relevant events 222 indicates the number of events with which the document is associated. The number of relevant event IDs 223 to be stored is equal to the number of relevant events 222.

The relevant event ID 223 is an identifier which uniquely identifies an event with which the document is associated. In general, the event ID of a meeting at which the document was distributed is stored.

The electronic file name 224 is the file name of the electronic data of the document.

The document size 225 indicates the size of the rectangular area for the document. For example, the coordinates of the upper left corner and the coordinates of the lower right corner of the area are stored. In the case shown in the figure, the document size 225 is shown in millimeters with the coordinates of the upper left corner as the origin.

The number of stroke sets 226 is the number of stroke sets handwritten on the document with the digital pen 14. The number of stroke set IDs 227 to be recorded is equal to the number of stroke sets 226.

A stroke set is a group of lines (strokes) to be regarded as a set. It is determined, for example, by layout analysis in character recognition. In the layout analysis, a stroke set is determined by identifying a set of lines on the basis of the time when the lines were drawn and/or the relative coordinates of the lines.

The stroke set ID 227 is an identifier which uniquely identifies a stroke set handwritten on the document, through which stroke set information (FIG. 8B) is linked.

The number of links 228 indicates the number of links set for the document. Since the document information 22A in this diagram is information about a document for which no link is set, “0” is recorded as the number of links 228.

FIG. 7B is a structure diagram of document information 22B about a document with link which is managed by the document management section 115 of the contents server 11 of the embodiment of this invention.

The document information 22B related to a document with link is the same as the document information 22A related to a document with no link (FIG. 7A), except that the document information 22B includes link information 229. The same parts are given the same reference numerals, and description thereof will be omitted.

The link information 229 includes the file name, display method, and display place of a link set for the document. In the case where the file is a document, a document ID is recorded as the link information 229 instead of a file name.

The display method included in the link information 229 indicates a method for displaying the file in the document. For example, if the display method is “ReducedDisplay”, the file is linearly reduced and displayed. If the display method is “TlmeScaleBar_V”, a time scale bar indicating the progress of watching and listening to the file is displayed. Further, by specifying a position on the time scale bar with the digital pen 14, the user can move the position to watch or listen to.

The display place included in the link information 229 indicates a rectangular area in which the file is displayed. For example, the relative coordinates of the upper left corner and the lower right corner of the rectangular area are recorded.

Other information such as the ratio of linear reduction may be also recorded as the link information 229.

FIG. 8A shows an example of a stroke set 26 of the embodiment of this invention.

The stroke set 26 indicates “TOKYO” handwritten with the digital pen 14. In this embodiment, the position of a stroke is determined with the upper left as the origin, the horizontal direction as the X axis, and the vertical direction as the Y axis as shown in the figure.

As described before, a stroke set is a group of lines (strokes) to be regarded as a set, and it is identified on the basis of the time when the lines were drawn and/or the positional relations among the lines.

FIG. 8B is a structure diagram of stroke set information 24 managed by the stroke set management section 116 of the contents server 11 of the embodiment of this invention.

This stroke set information 24 is stroke set information about the stroke set 26 shown in FIG. 8A.

The stroke set information 24 includes stroke set ID 241, handwriting start time and date 242, relevant rectangle area 243, the number of strokes 244, and stroke data 245.

The stroke set ID 241 is an identifier which uniquely identifies the stroke set.

The handwriting start time and date 242 is the time and date when handwriting of the stroke set was started.

The relevant rectangle area 243 indicates a rectangular area which includes the stroke set. The relevant rectangle area 243 includes coordinates (relative coordinates) on the document on which the stroke set was handwritten, and indicated by the coordinates of the upper left corner and the lower right corner of the rectangular area.

The number of strokes 244 is the number of lines (strokes) included in the stroke set. The number of stroke data 245 to be recorded is equal to the number of strokes 244.

The stroke data 245 includes the number of samples 245A and a serial number 245B.

The number of samples 245A is the number of relative coordinates acquired by the digital pen 14 on the stroke.

The serial number 245B is an identifier which uniquely identifies the relative coordinates acquired by the digital pen 14 on the stroke, through which stroke coordinate information 25 (FIG. 8C) is linked.

FIG. 8C is a structure diagram of the stroke coordinate information 25 managed by the stroke set management section 116 of the contents server 11 of the embodiment of this invention.

The stroke coordinate information 25 includes a serial number 251, an X coordinate 252, a Y coordinate 253, and acquisition time 254.

The serial number 251 is an identifier which uniquely identifies the relative coordinates acquired by the digital pen 14.

The X coordinate 252 is a relative coordinate in the X-axis direction shown in FIG. 8A and is indicated, for example, in millimeters.

The Y coordinate 253 is a relative coordinate in the Y-axis direction shown in FIG. 8A and is indicated, for example, in millimeters.

The acquisition time 254 indicates the time when the relative coordinates were acquired by the digital pen 14. In this diagram, the time that has elapsed since the handwriting start time and date 242 is started to be recorded as the acquisition time 254.

FIG. 9 is a structure diagram of user information 27 managed by the user management section 117 of the contents server 11 of the embodiment of this invention.

The user information 27 includes user ID 271, name 272, department 273, and official title 274.

The user ID 271 is an identifier which uniquely identifies the user.

The name 272 is the name of the user.

The department 273 is the department to which the user belongs.

The official title 274 is the official title of the user.

FIG. 10 is a diagram illustrating an event registration form 30 of the embodiment of this invention.

The event registration form 30 is filled in by the user when the user registers an event with the contents server 11. The event registration form 30 includes place 301, participants 302, title 303, additional information 304, time 305, and a “register” area 306 for the event.

Multiple areas in which place names are shown are provided after the item name “place” 301. The user specifies the area showing the place where the event is held, with the digital pen 14. For example, in this diagram, the place where the event is held is “YY Building”. The contents server 11 identifies the place where the event is held on the basis of the relative coordinates specified by the digital pen 14. Then, the contents server 11 registers the place where the event is held, which has been identified, as the place 213 in the event information 21.

By using, at each place, a different event registration form 30 to which a different dot pattern has been assigned, the place 301 in the event registration form 30 can be omitted. In this case, the contents server 11 identifies the place where the event is held, on the basis of the document ID of the event registration form 30.

Multiple areas in which user names are shown are provided after the item name “participants” 302. The user specifies an area corresponding to his/her own name with the digital pen 14. For example, in this diagram, the participants of the event are “Suzuki”, “Tanaka”, and “Sato”. The contents server 11 identifies the participant on the basis of the relative coordinates specified by the digital pen 14. Then, the contents server 11 registers the identified participants as the participant's user ID 215 in the event information.

A checkbox may be simply provided after the item name “participants” 302 instead of the areas in which user names are shown. In this case, all the participants check the checkbox with their own digital pen 14. Based on the ID of the user who owns the digital pen 14 which has checked the checkbox, the contents server 11 identifies the participant.

An empty box is provided after the item name “title” 303. The user handwrites the name of the event in this box with the digital pen 14. For example, in this figure, the title of the event is “YY Patent Discussion Meeting”. The contents server 11 uses a character recognition technique to recognize the characters handwritten with the digital pen 14, and converts them into text data. Then, the event name converted into a text is registered as the event name 211 in the event information 21.

Multiple areas in which the kinds of additional information are shown are provided after the item name “additional information” 304. The kinds of additional information include, for example, video and slide. The user specifies an area corresponding to the additional information to be registered in association with the event, with the digital pen 14. For example, in this diagram, “video” additional information and “slide” additional information are registered in association with the event.

The contents server 11 identifies the additional information associated with the event, on the basis of the relative coordinates specified by the digital pen 14, and registers the additional information as the additional information 217 in the event information 21. The additional information 304 may be omitted on the event registration form 30. In this case, the user registers additional information in the contents server 11 at an arbitrary timing (for example, after the meeting).

A “start” area and an “end” area are provided after the item name “time” 305. The user specifies the “start” area with the digital pen 14 when the event starts. The contents server 11 determines the time when the “start” area is specified with the digital pen 14 as the start time of the event. The user also specifies the “end” area with the digital pen 14 when the event ends. The contents server 11 determines the time when the “end” area is specified with the digital pen 14 as the end time of the event.

The “register” area 306 is for instructing the contents server 11 to register the event. When registering the event in the contents server 11, the user specifies the “register” area 306 with the digital pen 14. Then, the contents server 11 creates event information 21 regarding the event handwritten in the event registration form.

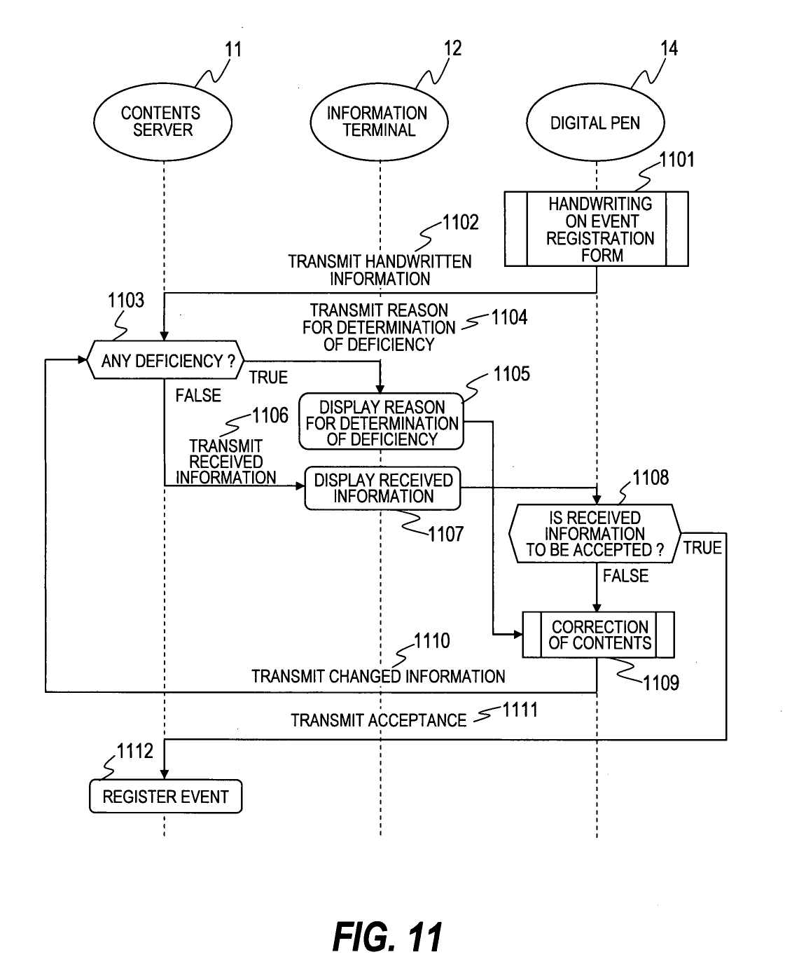

FIG. 11 is a sequence diagram of the event registration processing by the document management system of the embodiment of this invention.

First, the user handwrites predetermined information on the event registration form 30 with the digital pen 14 (1101). Specifically, the user specifies the place where the event is held, after the item name “place” 301 and specifies the participants of the event, after the item name “participants” 302 in the event registration form 30. The user also handwrites the name of the event after the item name “title” 303 in the event registration form 30. The user also specifies additional information to be registered in association with the event, after the item name “additional information” 304 in the event registration form 30. Further, the user specifies the “start” area provided after the item name “time” 305 in the event registration form 30 when the event starts, and specifies the “end” area provided after the item name “time” in the event registration form 30 when the event ends. After filling in the event registration form 30 for all the items included therein, the user specifies the “register” area 306.

Then, the digital pen 14 sends the information handwritten by the user to the contents server 11 (1102). This information sent by the digital pen 14 to the contents server 11 is usually transferred via the information terminal 12. Instead of handwriting the predetermined information on the event registration form 30, the user may input the information to the event information input device 15. In this case, the event information input device 15 sends the inputted information to the contents server 11.

When receiving the information sent by the digital pen 14 or the event information input device 15, the contents server 11 determines whether the received information is defective or not (1103). The deficiency of the received information means, for example, that necessary information is not handwritten on the event registration form 30, multiple places are specified as the place where the event is held, or the “end” area is specified prior to the “start” area.

When the received information is defective, the contents server 11 cannot register the event. Therefore, the contents server 11 sends a reason for determination of the deficiency to the information terminal 12 which has relayed the information sent from the digital pen 14 (1104). Then, the information terminal 12 displays the received reason for determination of the deficiency (1105). Then, the process proceeds to step 1109, where correction of the contents of the received information is requested.

On the other hand, when the received information is not defective, the contents server 11 sends the received information to the information terminal 12 (1106). Then, the information terminal 12 displays the received information (1107). The user is requested to input whether or not to accept the received information displayed on the information terminal 12 (1108).

When the user does not accept the received information, the user corrects the received information with the digital pen 14 (1109). Then, the digital pen 14 sends the changed information including the corrected contents to the contents server 11 (1110). The user may correct the received information with the use of the information terminal 12. In this case, the information terminal 12 sends the changed information including the corrected contents to the contents server 11. Then, the process returns to step 1103, and the processing is repeated.

On the other hand, when the user accepts the received information, the user inputs acceptance of the received information with the digital pen 14. Then, the digital pen 14 sends the acceptance of the received information to the contents server 11 (1111). The user may also input the acceptance of the received information to the information terminal 12. In this case, the information terminal 12 sends the acceptance of the received information to the contents server 11.

The contents server 11 registers the received information which has been accepted, as event information 21 (1112). Specifically, the contents server 11 performs the following processing.

First, new event information 21 is created. Next, the event ID of the event is determined in a manner that it does not overlap with any of the event IDs of other events, and the determined event ID is recorded as the event ID 210 in the new event information 21.

Further, the name handwritten as the title 303 in the event registration form 30 is recorded as the event name 211 in the new event information 21.

Further, the time when the “start” area after the item name “time” 305 in the event registration form 30 is specified and the time when the “end” area after the item name “time” 305 is specified are recorded as the time and date 212 in the new event information 21.

Further, the name of the place corresponding to the area specified after the item name “place” 301 in the event registration form 30 is recorded as the place 213 in the new event information 21.

Further, the number of the areas specified after the item name “participants” 302 in the event registration form 30 is recorded as the number of participants 214 in the new event information 21.

Further, the user IDs corresponding to the areas specified after the item name “participants” 302 in the event registration form 30 are determined, and the determined user IDs are recorded as the participants' user IDs 215 in the new event information 21.

Further, the number of areas specified after the item name “additional information” 304 in the event registration form 30 is recorded as the number of pieces of additional information 216 in the new event information 21.

Meanwhile, the event information input device 15 creates a video and the like related to the event. Next, the event information input device 15 registers the video and the like which have been created, with the contents server 11 as additional information. Then, the contents server 11 records the file names of the registered additional information as additional information 217 in the new event information 21.

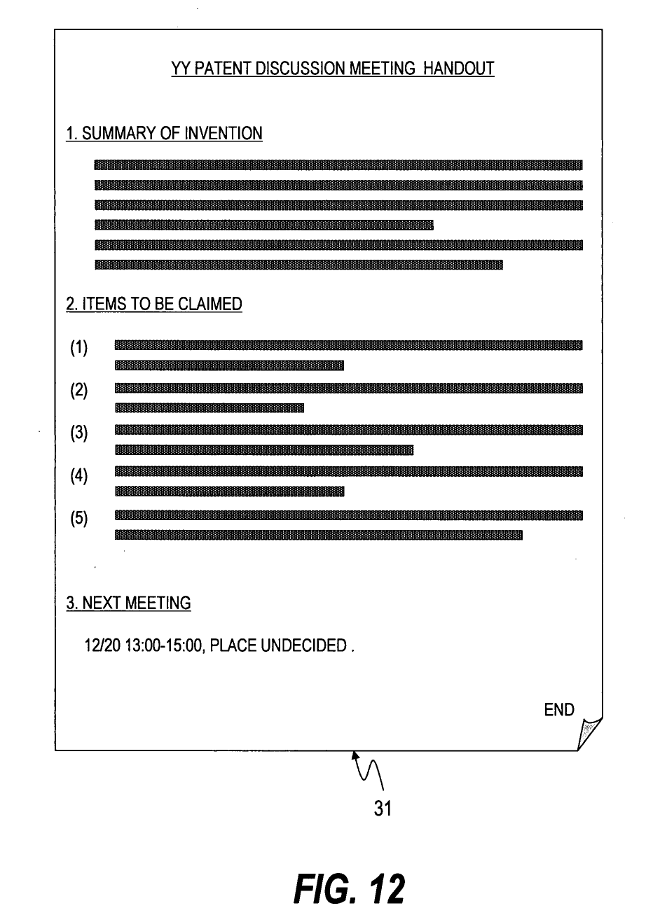

The user registers a document related to the event with the contents server 11 with the use of the event information input device 15 or the information terminal 12. For example, the user registers a document as will be described later with reference to FIG. 12. Then, the contents server 11 identifies the document ID of the registered document and records the identified document ID as the document ID 219 in the new event information 21. The number of documents 218 in the new event information 21 is incremented. Further, the contents server 11 creates document information related to the registered document.

As described above, the contents server 11 of this embodiment manages the contents handwritten on the event registration form 30 and the like as the event information 21. For example, by the user handwriting the contents shown in FIG. 10 on the event registration form 30, the contents server 11 creates the event information 21 shown in FIG. 6.

FIG. 12 is a diagram illustrating a document 31 to be registered with the contents server 11 of the embodiment of this invention.

The user registers a document (distributed data) 31 as shown in the figure, with the contents server 11 in association with the event for which the document 31 has been distributed.

A different dot pattern is assigned to each document 31. In other words, each document is printed on paper on which a different dot pattern is printed in advance. The documents having different dot patterns have different document IDs 220 and are distributed to different users.

The document 31 may be a document which has been electronically created with document creation software or the like, or may be a document obtained by converting a handwritten document into an electronic document.

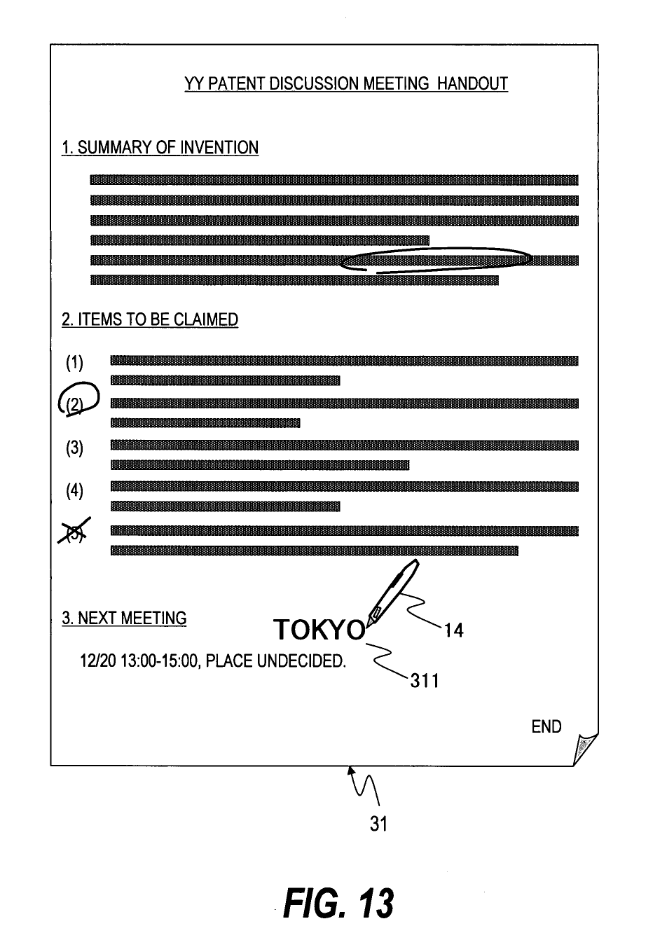

FIG. 13 is a diagram illustrating the document 31 in which information has been handwritten with the digital pen 14 of the embodiment of this invention.

This diagram shows a state where information has been handwritten on the document described with reference to FIG. 12, by the digital pen 14.

The user handwrites information (a character, a symbol, or the like) on the document 31 with the digital pen 14 during the event (or after the event). Then, the digital pen 14 periodically acquires the absolute coordinates of the positions where the characters or the like are being handwritten (the position where the pen point is touching the paper) and the time when the absolute coordinates are measured. Next, the digital pen 14 sends stroke information which includes the acquired absolute coordinates and measurement time to the contents server 11.

Then, by making an inquiry to the position information server 18, the contents server 11 identifies the document ID and relative coordinates corresponding to the absolute coordinates included in the received stroke information.

Then, the contents server 11 determines the stroke of the handwritten information on the basis of the identified relative coordinates and measurement time, and creates stroke coordinate information 25. Then, the contents server 11 creates new stroke set information with the use of the identified document ID. For example, when “TOKYO” 311 is handwritten on the document 31 with the digital pen 14, the contents server 11 creates the stroke set information 24 shown in FIG. 8B and the stroke coordinate information 25 shown in FIG. 8C.

Next, the contents server 11 reflects the information handwritten with the digital pen 14, on the document. Specifically, the contents server 11 retrieves such document information 22 whose document ID 220 matches the document ID included in the received stroke information, from the document management section 115. Then, the number of stroke sets 226 in the retrieved document information 22 is incremented. The stroke set ID 241 in the created stroke set information 24 is stored as the stroke set ID 227 in the document information 22.

As described above, the contents server 11 reflects information handwritten with the digital pen 14, on a registered document.

FIG. 14 is a diagram illustrating a search form 32 of the embodiment of this invention.

The user fills in the search form 32 when the user requests contents server 11 to search for an event. The search form 32 includes a period 321, a place 322, participants 323, a keyword 324, and a “start search” area 325.

A bar indicating months and years is provided after the item name “period” 321. The user specifies the period during which the event the user wishes to search for was held, with the digital pen 14. In this diagram, the user specifies an event which was held in 2004. The contents server 11 determines the period to be a search condition on the basis of the relative coordinates specified by the digital pen 14. Then, the contents server 11 retrieves such event information 21 whose time and date 212 is included in the specified period, from the event management section 114. If the user does not specify the period during which the event was held, the contents server 11 searches for the event without limiting the period during which the event was held.

Multiple areas in which place names are shown are provided after the item name “place” 322. The user specifies the area corresponding to the place where the event the user wishes to search for was held, with the digital pen 14. In this diagram, the user specifies an event held at “YY Building” or “YY Office”. The contents server 11 determines the place of the event, which is to be a search condition, on the basis of the relative coordinates specified by the digital pen 14. Then, the contents server 11 retrieves such event information 21 whose place 213 matches the specified place, from the event management section 114.

The user may specify multiple places. In this case, the contents server 11 retrieves such event information 21 whose place 213 matches any of the specified places, from the event management section 114. If the user does not specify the place of the event, the contents server 11 searches for the event without limiting the place of the event.

Multiple areas in which user names are shown are provided after the item name “participants” 323. The user specifies an area corresponding to a participant of the event which the user wishes to search for, with the digital pen 14. In this diagram, the user specifies such an event that “Suzuki” is included as a participant.

The contents server 11 determines the participant name to be a search condition on the basis of the relative coordinates specified by the digital pen 14. Next, the contents server 11 retrieves user information 27 whose name 272 matches the determined participant name, from the user management section 117, and extracts the user ID 271 from the retrieved user information 27. Then, the contents server 11 retrieves such event information 21 whose participant user ID 215 includes the extracted user ID 271, from the event management section 114. If the user does not specify a participant of the event, the contents server 11 searches for the event without specifying any participant.

One or more empty boxes are provided after the item name “keyword” 324. The user handwrites a keyword related to the event the user wishes to search for in the box with the digital pen 14. The contents server 11 recognizes the characters handwritten with the digital pen 14 with the use of a character recognition technique. Then, the contents server 11 retrieves such event information 21 whose event name 211 includes the recognized characters, from the event management section 114.

The contents server 11 may create stroke set information of the characters handwritten as the keyword 324 with the digital pen 14. In this case, the contents server 11 retrieves such stroke set information 24 that closely resembles the created stroke set information, from the stroke set management section 116 with the use of a pattern matching technique. Then, the contents server 11 searches for an event related to the retrieved stroke set information 24.

The “start search” area 325 is for requesting the contents server 11 to start a search. In other words, the user specifies the “start search” area 325 with the digital pen 14 after handwriting necessary contents on the search form 32. Then, the contents server 11 retrieves such event information 21 that satisfies the search condition handwritten on the search form 32, from the event management section 114.

Other search conditions may be handwritten on the search form 32.

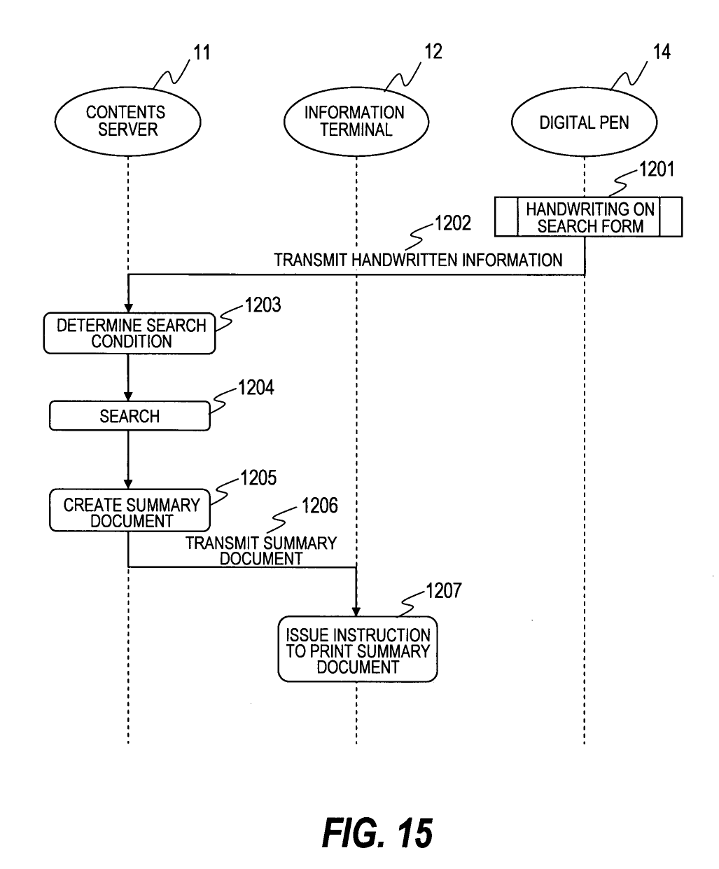

FIG. 15 is a sequence diagram of the event search processing by the document management system according to the embodiment of this invention.

First, the user handwrites search conditions on the search form 32 with the use of the digital pen 14 (1201). Then, the user specifies the “start search” area 325 in the search form 32 with the digital pen 14 after handwriting all the search conditions.

Then, with the digital pen 14, the handwritten information including the search conditions handwritten by the user is sent to the contents server 11 (1202). This information sent to the contents server 11 by the digital pen 14 is usually transferred via the information terminal 12. The user may input the search conditions to the information terminal 12 instead of handwriting them on the search form 32. In this case, the information terminal 12 sends the inputted information to the contents server 11.

When receiving the information sent from the digital pen 14 or the information terminal 12, the contents server 11 determines the search conditions from the information (1203). Next, the contents server 11 retrieves such event information 21 that satisfies the determined search conditions, from the event management section 114 (1204).

Next, the contents server 11 creates a summary document about the retrieved event information 21 (1205). Specifically, the contents server 11 extracts all the document IDs 219 included in the retrieved event information 21. Next, the contents server 11 creates a summary document by linearly reducing the documents corresponding to the extracted document IDs 219 and attaching them onto a template. It is also possible to linearly expand a part of the documents corresponding to the extracted document IDs 219 and attaching them onto the template.

Further, the contents server 11 may extract the additional information 217 in the retrieved event information 21 and attach images related to the extracted additional information 217 onto the template. The template may be set in advance, or the user may select one from among multiple templates prepared in advance.

However, if multiple pieces of event information 21 are found in step 1204, the contents server 11 may notify the information terminal 12 to the effect that the multiple events have been retrieved, and the contents server 11 does not have to create the summary document.

Next, the contents server 11 assigns any of arbitrary dot patterns which do not overlap with one another to the created summary document. Next, the contents server 11 sends the summary document to which the dot pattern has been assigned, to the information terminal 12 which has relayed the information sent by the digital pen 14 (1206).

The information terminal 12 receives the summary document from the contents server 11. Next, the information terminal 12 instructs the printer 16 to print the received summary document (1207). Then, the printer 16 prints the specified summary document. The information terminal 12 may display the summary document upon receiving the summary document.

FIG. 16 is a diagram illustrating a summary document 33 of the embodiment of this invention.

This summary document 33 was created by the contents server 11 which has received the search conditions shown in FIG. 14.

The contents server 11 searched for an event which satisfies all the conditions: the period 321 (year 2004), the place 322 (YY Building or YY Office), and the participant 323 (Suzuki) specified by the user. As a result, two events, “YY Patent Discussion Meeting” and “ZZ Commercialization Meeting” were found. Then, the contents server 11 created the summary document 33 on these two events.

The upper half of the summary document 33 is a summary on a “YY Patent Discussion Meeting”, and the lower half is a summary on a “ZZ Commercialization Meeting”. The summary document 33 includes a title 330, time and date 331, place 332, participants 333, timescale bar 334, image 335, “reduced document” area 336, “print” area 337, “video search” area 338, and “print all” area 339.

The title 330 indicates the name of the event.

The time and date 331 indicates the start time and end time of the event.

The place 332 indicates the name of the place where the event was held.

As the participants 333, the names of participants in the event are shown.

The timescale bar 334 is a bar that corresponds to the time in the video related to the event. If the user specifies an area on the timescale with the digital pen 14, a video shot at the time corresponding to the specified area is displayed on the information terminal 12.

The image 335 is one frame extracted from the video related to the event. The image 335 may be one frame at the start time or at the end time, or it may be one frame at any time after the start time.

To the “reduced document” area 336, a document related to the event is reduced and attached. The summary document 33 includes the same number of “reduced document” areas 336 as the number of documents 218 in the event information 21 of the event. For example, in the summary document 33 on the “YY Patent Discussion Meeting”, four “reduced document” areas 336 are included. In a “reduced document” area 336A of the “reduced document” areas 336, the document 31 is reduced and attached.

The “print” areas 337 are provided to correspond to the respective “reduced document” areas 336. For example, the user specifies the “print” area 337 with the digital pen 14. Then, the contents server 11 retrieves document information 22 on the document attached into the “reduced document” area 336 corresponding to the specified “print” area 337 from the document management section 115, with the use of the document ID of the specified reduced document. Then, the contents server 11 instructs the printer 16 to print the file identified by the electronic file name 224 which is included in the retrieved document information 22.

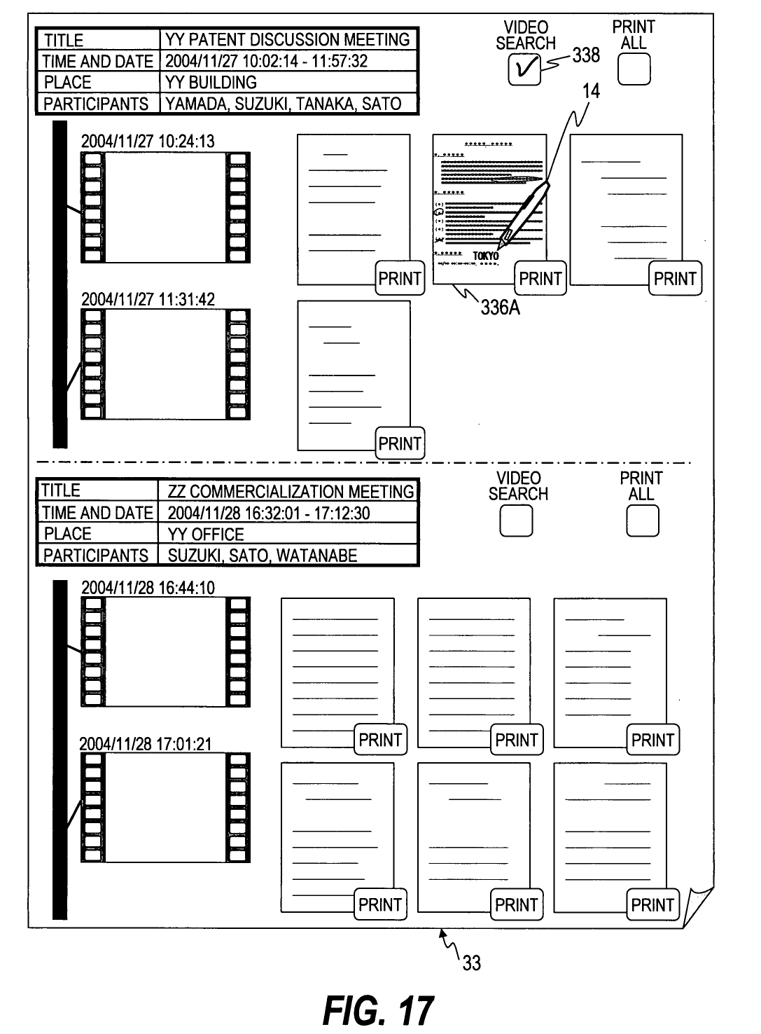

The “video search” area 338 will be described in detail with reference to FIG. 17.

The “print all” area 339 requests printing of all the documents related to the event. For example, when the user specifies the “print all” area 339 with the digital pen 14, the contents server 11 extracts all the document IDs 219 from the event information 21 related to the event. Next, the contents server 11 retrieves such document information 22 whose document ID 220 matches any of the extracted document IDs 219, from the document management section 115. Then, the contents server 11 extracts the electronic file names 224 from the retrieved document information 22 and instructs the printer 16 to print the files identified by the extracted electronic file names 224.

Next, the processing performed by the contents server 11 to create the summary document 33 will be described.

The contents server 11 has a template of the summary document 33, which is provided in advance with the timescale bar 334, the “print” areas 337, the “video search” area 338, and the “print all” area 339. The contents server 11 creates a summary document by attaching various pieces of information to this template.

Specifically, the event name 211 in the event information 21 retrieved by the search processing (FIG. 15) is written as the title 330; the time and date 212 in the event information 21 is written as the time and date 331; and the place 213 in the event information 21 is written as the place 332. Such user information 27 whose user ID 271 matches any of the participants' user IDs in the event information 21 is retrieved from the user management section 117. Then, the names 272 are extracted from the retrieved user information 27, and the extracted names 272 are written as the participants 333.

Next, an arbitrary image is extracted from the files of the additional information 27 in the event information 21. Then, the extracted image is attached as the image 335 in the summary document 33. Next, from the event information 21, all the document IDs 219 are extracted. Next, such document information 22 whose document ID 220 matches any of the extracted document IDs 219 is retrieved from the document management section 115. Then, the electronic file names 224 are extracted from the retrieved document information 22, and the files identified by the extracted electronic file names 224 are linearly reduced. Then, the linearly reduced files are attached into the “reduced document” areas 336.

FIG. 17 is a diagram illustrating the summary document 33 of the embodiment of this invention, and shows a state where video search processing is specified.

The video search processing is processing for searching for a video shot at the time when information was handwritten on the document attached to the summary document 33. In this diagram, the processing for searching for a video shot at the time when “TOKYO” was handwritten on the document 31 will be described.

First, the user specifies the “video search” area 338 in the summary document 33 with the digital pen 14. Next, the user specifies “TOKYO” printed on the “reduced document” area 336A in the summary document 33 with the digital pen 14. The digital pen 14 sends the specified position to the contents server 11.

The contents server 11 receives the absolute coordinates of the position specified by the digital pen 14. Next, the document ID and the relative coordinates are identified on the basis of the received absolute coordinates. Next, such document information 22 whose document ID 220 matches the identified document ID is retrieved from the document management section 115. Next, which document information 22 includes the identified relative coordinates (the position specified by the digital pen 14) in the rectangular area of the link information 229 is retrieved from among the retrieved pieces of document information 22. Then, the document information 22 in which the position specified by the digital pen 14 is included within the rectangular area is extracted.

Next, from the identified relative coordinates, the coordinates of the upper left corner of the rectangular area stored in the extracted link information 229 are subtracted. Accordingly, the identified relative coordinates are converted into the coordinates with the upper left corner of the “reduced document” area 336A as the origin.

Next, the ratio of linear reduction of the document 31 attached into the “reduced document” area 336A in step 1205 of FIG. 15 is determined. Specifically, from the coordinates of the rectangular area stored in the extracted link information 229, the size of the rectangular area is determined. Next, the document size 225 is extracted from the document information 22 related to the document 31. Then, the ratio of linear reduction of the document 31 is determined by dividing the size of the rectangular area by the extracted document size 225.

Next, the coordinates with the upper left corner of the “reduced document” area 336A as the origin are multiplied by the reciprocal of the determined ratio. Accordingly, the relative coordinates on the document 31 attached into the “reduced document” area 336A are determined.

Next, such document information 22 whose document ID 220 matches the document ID stored in the extracted link information is retrieved from the document management section 115. Accordingly, the document information 22 related to the document 31 attached into the “reduced document” area 336A is retrieved.

Next, from the retrieved document information 22, all the stroke set IDs 227 are extracted. Next, such stroke set information 24 whose stroke set ID 241 matches any of the extracted stroke set IDs 227, and whose rectangular area 243 includes the relative coordinates on the document 31 attached into the “reduced document” area 336A is retrieved from the stroke set management section 116. Accordingly, the stroke set information 24 related to the stroke handwritten in the area specified by the digital pen 14 is retrieved.

Next, from the retrieved stroke set information 24, the handwriting start time and date 242 is extracted. Accordingly, the time when the information was handwritten in the area specified by the digital pen 14 is identified. Then, a video shot at the identified handwriting start time, among the video files recorded as links 229 in the document information 22, is sent to the information terminal 12.

After that, the information terminal 12 displays the received video.

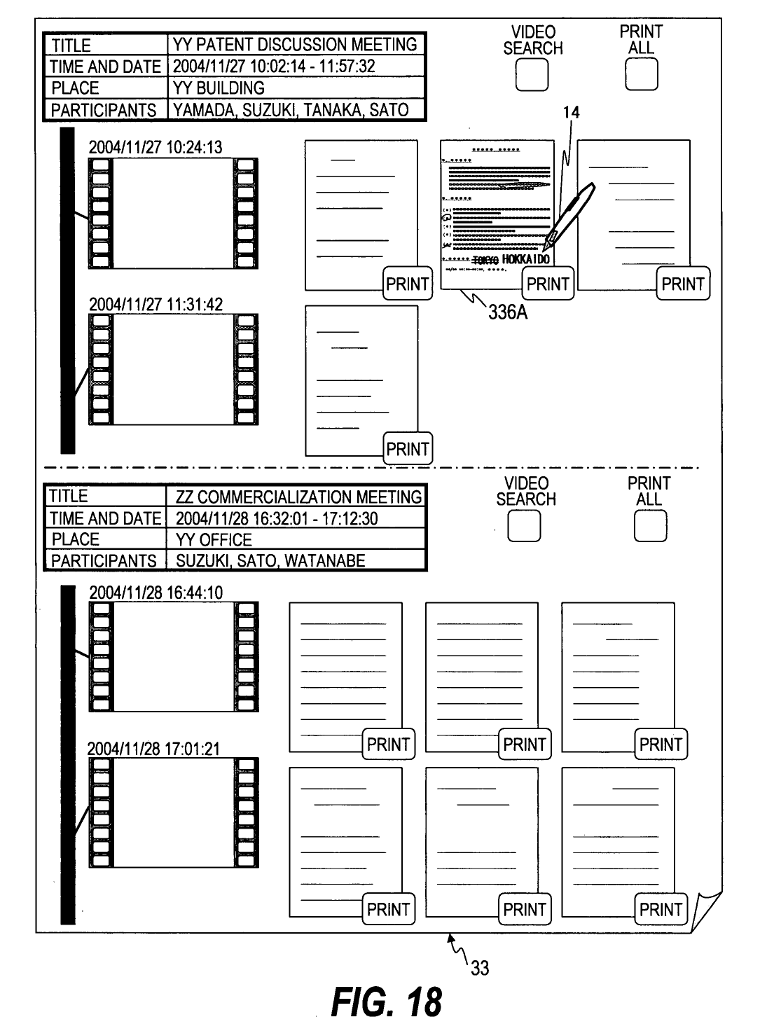

FIG. 18 is a diagram illustrating the summary document 33 of the embodiment of this invention, and shows a state where document addition processing is specified.

The document addition processing is processing for, when information is handwritten in the “reduced document” area 336A in the summary document 33, reflecting the handwritten information on the document 31 attached into the “reduced document” area 336A as well. In this diagram, the processing for correcting “TOKYO” handwritten on the document 31 to “HOKKAIDO” will be described.

The user draws two horizontal lines on “TOKYO” printed on the “reduced document” area 336A in the summary document 33 and handwrites “HOKKAIDO” on the right side thereof with the digital pen 14.

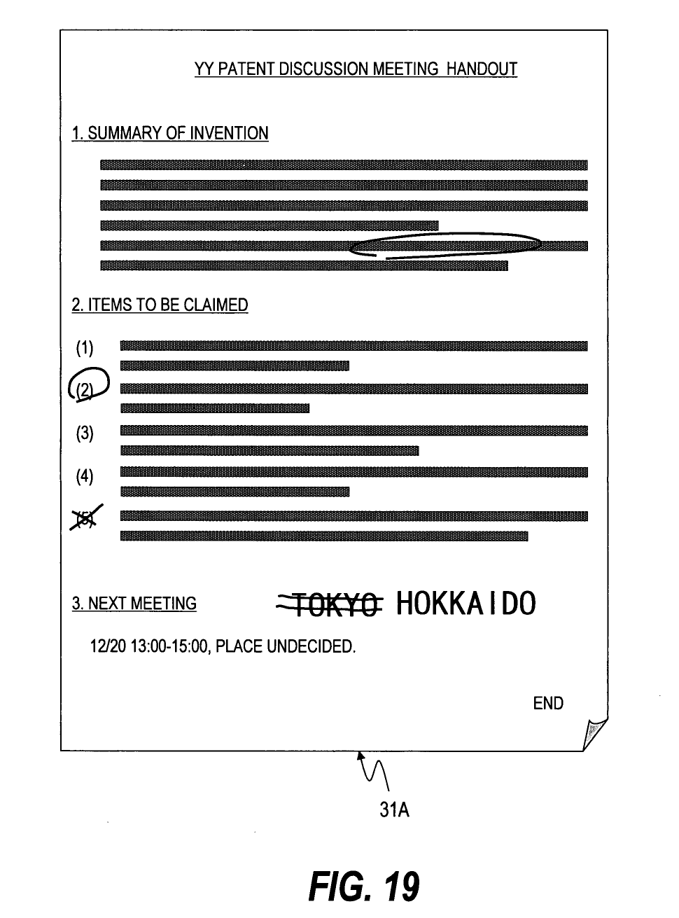

Then, the contents server 11 reflects the information handwritten with the digital pen 14 on the summary document 33. Further, the contents server 11 also reflects the handwritten information on the document 31 attached into the “reduced document” area 336A in the summary document 33. Accordingly, the contents server 11 reflects the handwritten information on the document 31 (FIG. 13). Then, the document 31 is managed as the document 31A shown in FIG. 19.

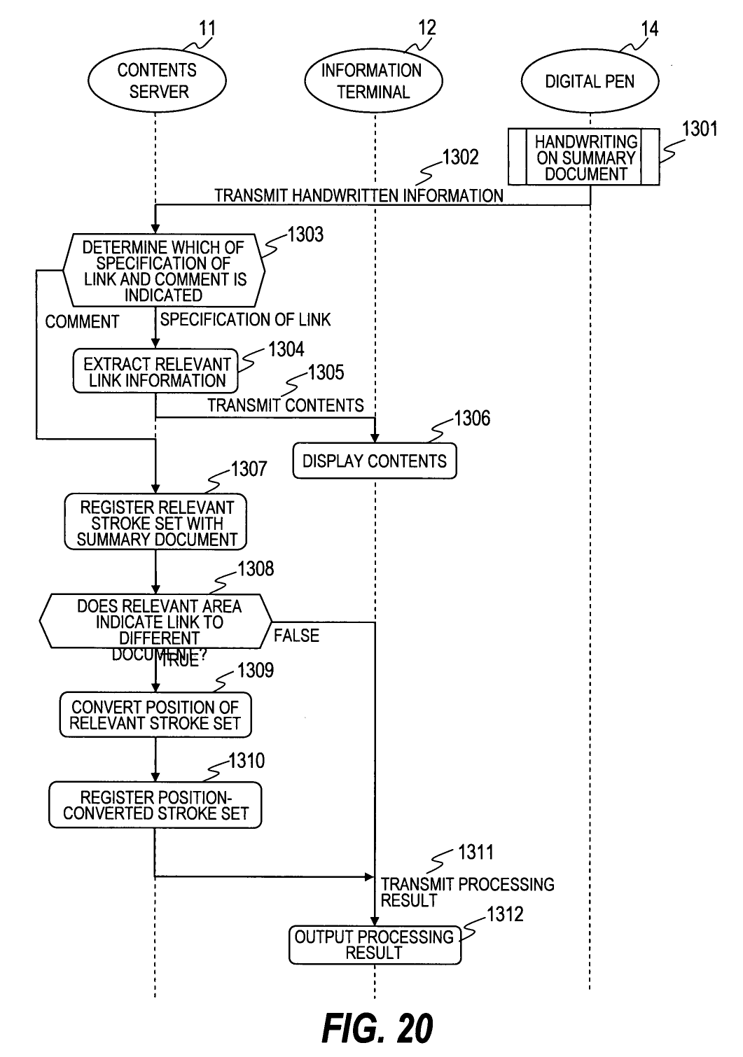

FIG. 20 is a sequence diagram of the summary document operation processing by the document management system according to the embodiment of this invention.

The user handwrites information on the summary document 33 with the digital pen 14 (1301). Then, the digital pen 14 sends the information handwritten by the user to the contents server 11 (1302). This handwritten information includes stroke information containing the absolute coordinates of the position the digital pen is touching and the time when the absolute coordinates are acquired.

Next, by making an inquiry to the position information server 18, the contents server 11 identifies the document ID and relative coordinates corresponding to the absolute coordinates included in the received handwritten information. Next, the contents server 11 determines strokes from the identified relative coordinates, through layout analysis.

Next, the contents server 11 determines which of a specification of a link or a comment the received handwritten information is on the basis of the number of the determined strokes and/or the length thereof (1303). For example, when the length of the stroke is equal to or below a threshold, the contents server 11 determines the information to be a specification of a link. When the length is above the threshold, the contents server 11 determines the information to be a comment.

When the information is a specification of a link, the contents server 11 extracts link information corresponding to the user's request (1304).

Specifically, the contents server 11 retrieves such document information 22 whose document ID 220 matches the identified document ID, from the document management section 115. Next, the contents server 11 extracts such link information 229 in which the identified relative coordinates are included within the rectangular area shown in the link information 229 in the document information 22.

Then, the contents server 11 sends contents corresponding to the extracted link information 229 to the information terminal 12 (1305). The information terminal 12 displays the received contents (1306).

When contents related to the video search processing are stored in the extracted link information 229, the contents server 11 performs the processing described with reference to FIG. 17.

On the other hand, when the information is a comment, the contents server 11 creates stroke set information 24 and stroke coordinate information 25 on the basis of the information received via the digital pen 14.

Specifically, by making an inquiry to the position information server 18, the contents server 11 identifies relative coordinates corresponding to the absolute coordinates included in the information received from the digital pen 14. Then, the contents server 11 stores the identified relative coordinates and the time when the coordinates included in the information received from the digital pen 14 were acquired, in the stroke coordinate information 25.

Next, the contents server 11 retrieves such document information 22 whose document ID 220 matches the identified document ID, from the document management section 115. Next, the contents server 11 stores the stroke set ID 241 in the created stroke set information 24 as the stroke set ID 227 in the document information 22. Further, the contents server 11 increments the number of stroke sets 226 in the document information 22. Accordingly, the contents server 11 registers the stroke set handwritten in the digital pen 14 with the summary document 33 (1307).

Next, it is determined which link information 229 in the document information 22 includes the identified relative coordinates (the position specified by the digital pen 14) in the rectangular area thereof. Then, such link information 229 in which the position specified by the digital pen 14 is included in the rectangular area thereof is extracted. Then, it is determined whether the extracted link information 229 indicates a link to a different document or not (1308). In other words, it is determined whether the area where handwriting was performed with the digital pen 14 is the “reduced document” area 336 or not.

When the link information 229 does not indicate a link to a different document, the contents server 11 sends a processing result to the information terminal 12 (1311). The processing result is, for example, a summary document 33 on which the information handwritten with the digital pen 14 has been reflected. Then, the information terminal 12 displays the received processing result (1322).

On the other hand, if the link information 229 indicates a link to a different document, the contents server 11 creates stroke coordinate information 25 in which the stroke set registered in step 1307 has been converted into the position on the linked document (1309). Specifically, the contents server 11 performs the following processing for all the relative coordinates included in the stroke coordinate information 25 created in step 1307.

First, from the relative coordinates in the stroke coordinate information 25, the coordinates of the upper left corner of the rectangular area shown in the link information 229 extracted in step 1308 are subtracted. Accordingly, the relative coordinates in the stroke coordinate information 25 are converted into the coordinates with the upper left corner of the “reduced document” area 336 as the origin.

Next, the ratio of linear reduction of the document 31 attached into the “reduced document” area 336A in step 1205 of FIG. 15 is determined. Specifically, from the coordinates of the rectangular area stored in the link information 229 extracted in step 1308, the size of the rectangular area is determined. Next, the document size 225 is extracted from the document information 22 related to the document 31. Then, the ratio of linear reduction of the document 31 is determined by dividing the size of the rectangular area by the extracted document size 225.

Next, the coordinates with the upper left corner of the “reduced document” area 336 as the origin are multiplied by the reciprocal of the determined ratio. Accordingly, the relative coordinates on the document 31 attached into the “reduced document” area 336 are determined. Then, by storing the determined relative coordinates on the document 31 in the stroke coordinate information 25, the stroke coordinate information 25 related to the document 31 is created. Next, stroke set information 24 corresponding to the stroke coordinate information 25 is created.

Next, the stroke set ID 241 in the created stroke set information 24 is stored as the stroke set ID 227 in the document information 22 related to the document 31. Further, the number of stroke sets 226 in the document information 22 is incremented. Accordingly, the contents server 11 registers the position-converted stroke set in another document 31 linked to the area (1310).

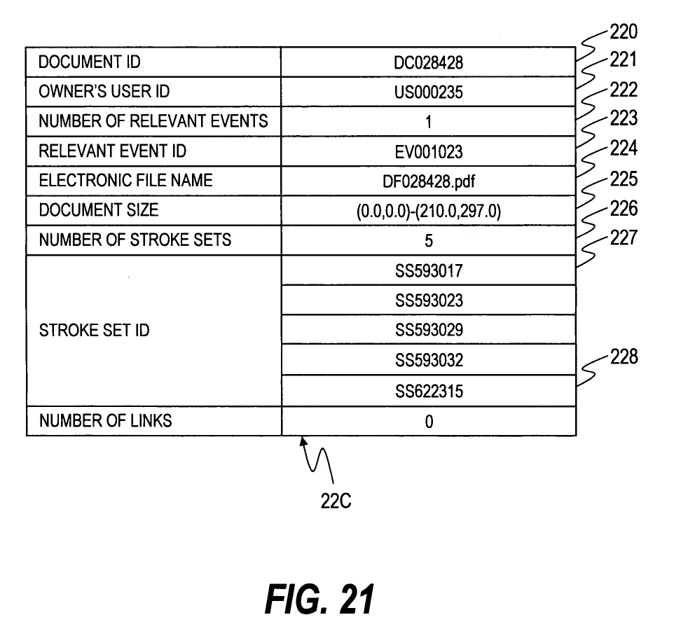

For example, when information is handwritten in the “reduced document” area 336A of the summary document 33 as shown in FIG. 18, the contents server 11 changes the document information 22A related to the document 31 (FIG. 7A) to the document information 22C shown in FIG. 21.

FIG. 21 is a structural diagram of the document information 22C related to the document 31 for which the document addition processing has been performed according to the embodiment of this invention.

The document information 22C shown in FIG. 21 is the same as the document information 22A shown in FIG. 7 except for the number of stroke sets 226 and the stroke set IDs 227. The number of stroke sets 226 has been increased. To the stroke set IDs 227, “SS622315” has been added.

Returning to FIG. 20, the contents server 11 sends a processing result to the information terminal 12 after step 1310 (1311). The processing result is, for example, a summary document 33 and a document 31 on which the information handwritten with the digital pen 14 has been reflected. Then, the information terminal 12 displays the received processing result (1322).

### INDUSTRIAL APPLICABILITY

This invention is useful for a system for managing paper and electronic data recorded with a document, and in particular, for a document management system and the like.

1. An information management system comprising a coordinate acquisition device for identifying a position on paper and a contents server for storing document data, characterized in that:
the document data includes original document data and summary document data including the original document data;
the original document data includes a first coordinate system and contents;
the summary document data includes a second coordinate system, information about link to the original document data, and coordinate information about an area assigned to the original document data; and
in a case where the coordinate acquisition device identifies a position on the summary document, the contents server converts the coordinates of the identified position in the second coordinate system to coordinates in the first coordinate system.

2. The information management system according to claim 1, characterized in that:
the summary document data includes the original document data a page size of which has been reduced; and
the contents server converts the coordinates in the second coordinate system to the coordinates in the first coordinate system, by using a page reduction ratio of the original document data in the summary document data and the coordinate information about the area assigned to the original document data.

3. The information management system according to claim 1, characterized in that:
the summary document data includes the original document data with different page sizes; and
in a case where the coordinate acquisition device identifies the position of the area assigned any of the original document data on the summary document, the contents server converts the coordinates of the identified position in the second coordinate system to the coordinates in the first coordinate system, and records, at the position of the converted coordinates on the original document data, that the position has been identified by the coordinate acquisition device.

4. The information management system according to claim 1, characterized in that, in a case where conditions for creating the summary document data are given, the contents server creates the summary document data by retrieving the original document data that satisfies the given conditions, reducing the page size of the retrieved original document data so as to fit to a predetermined summary document data template and assigning the original document data the page size of which has been reduced to an area provided on the template.

5. The information management system according to claim 1, characterized in that:
the original document data includes stroke information including coordinates of the position identified by the coordinate acquisition device and a time when the position is identified; and
the contents server stores video data related to the original document data, determines, in a case where the coordinate acquisition device identifies a position related to the stroke information in the area assigned to any of the original document data on the summary document, the time included in the stroke information corresponding to the identified position, and retrieves a video at the determined time from among the video data related to the original document data.

6. The information management system according to claim 1, characterized in that:
the document data includes stroke information including the coordinates of the position identified by the coordinate acquisition device and a time when the position is identified; and
the contents server determines, on the basis of a length of a trace of the position identified by the coordinate acquisition device, whether to record the stroke information including the coordinates of the position identified by the coordinate acquisition device and the time when the position is identified, in the document data, or perform predetermined processing on the assumption that the position identified by the coordinate acquisition device has been specified.

7. The information management system according to claim 1, characterized in that the contents server causes the summary document data to be usable as the original document data by setting the first coordinate system for the summary document data.

8. A document information management method for an information management system including a coordinate acquisition device for identifying a position on paper and a contents server for storing document data, the document information management method being characterized in that:
the document data includes original document data and summary document including the original document data;
the original document data includes a first coordinate system and contents;
the summary document data includes a second coordinate system, information about link to the original document data, and coordinate information about an area assigned to the original document data; and
in a case where the coordinate acquisition device identifies a position on the summary document, the contents server converts the coordinates of the identified position in the second coordinate system to coordinates in the first coordinate system.

9. The document information management method according to claim 8, characterized in that:
the summary document data includes the original document data a page size of which has been reduced; and
the contents server converts the coordinates in the second coordinate system to the coordinates in the first coordinate system, by using a page reduction ratio of the original document data in the summary document data and the coordinate information about the area assigned to the original document data.

10. The document information management method according to claim 8, characterized in that:
the summary document data includes the original document data with different page sizes; and
in a case where the coordinate acquisition device identifies the position of the area assigned to any of the original document data on the summary document, the contents server converts the coordinates of the identified position in the second coordinate system to the coordinates in the first coordinate system, and records, at the position of the converted coordinates on the original document data, that the position has been identified by the coordinate acquisition device.

11. The document information management method according to claim 8, characterized in that, in a case where conditions for creating the summary document data are given, the contents server creates the summary document data by retrieving the original document data that satisfies the given conditions, reducing the page size of the retrieved original document data so as to fit to a predetermined summary document data template and assigning the original document data the page size of which has been reduced to an area provided on the template.

12. The document information management method according to claim 8, characterized in that:
the original document data includes stroke information including coordinates of the position identified by the coordinate acquisition device and a time when the position is identified; and
the contents server stores video data related to the original document data, determines, in a case where the coordinate acquisition device identifies a position related to the stroke information in the area assigned to any of the original document data on the summary document, the time included in the stroke information corresponding to the identified position, and retrieves a video at the determined time from among the video data related to the original document data.

13. The document information management method according to claim 8, characterized in that:
the document data includes stroke information including the coordinates of the position identified by the coordinate acquisition device and a time when the position is identified; and
the contents server determines, on the basis of a length of a trace of the position identified by the coordinate acquisition device, whether to record the stroke information including the coordinates of the position identified by the coordinate acquisition device and the time when the position is identified, in the document data, or perform predetermined processing on the assumption that the position identified by the coordinate acquisition device has been specified.

14. The document information management method according to claim 8, characterized in that the contents server causes the summary document data to be usable as the original document data by setting the first coordinate system for the summary document data.
